(19) United States
(12) Patent Application Publication
(10) Pub. No.: US 2014/0270177 A1
(43) Pub. Date: Sep. 18, 2014

(54) HARDENING INTER-DEVICE SECURE COMMUNICATION USING PHYSICALLY UNCLONABLE FUNCTIONS

(71) Applicants: Ernie Brickell, Hillsboro, OR (US); Jiangtao Li, Beaverton, OR (US)

(72) Inventors: Ernie Brickell, Hillsboro, OR (US); Jiangtao Li, Beaverton, OR (US)

(21) Appl. No.: 13/844,559

(22) Filed: Mar. 15, 2013

(51) Int. Cl. H04L 9/08

(52) U.S. Cl. CPC H04L 9/0822
USPC 380/278

(57) ABSTRACT

Embodiments of an invention for hardened inter-device secure communication using physically unclonable functions are disclosed. In one embodiment, an apparatus includes a first storage location, a second storage location, a physically unclonable function (PUF) circuit, a PUF key generator, and an encryption unit. The first storage location is to store an embedded key. The second storage location is to store a fuse key. The PUF circuit is to provide a PUF value. The PUF key generator is to generate a PUF key based on the PUF value. The encryption unit is to receive from a key server a global key encrypted using the embedded key, decrypt the global key using the embedded key, encrypt the global key using the PUF key, and store the global key encrypted using the PUF key in the second storage location.

### BACKGROUND

1. Field

The present disclosure pertains to the field of electronic devices, and more particularly, to the field of security in electronic devices.

2. Description of Related Art

Confidential information is stored, transmitted, and used by many electronic devices. Therefore, many such devices include one or more components having one or more cryptographic or other secret keys, which may be used to protect the security of confidential information with encryption or other techniques. These keys may be embedded in and/or programmed into components during one or more steps in the manufacturing process.

### BRIEF DESCRIPTION OF THE FIGURES

The present invention is illustrated by way of example and not limitation in the accompanying figures.

FIG. 1 illustrates an integrated circuit providing for hardened secure inter-device communication according to an embodiment of the present invention.

FIG. 2 illustrates an encryption unit according to an embodiment of the present invention.

FIG. 3 illustrates a method for key provisioning according to an embodiment of the present invention.

FIG. 4 illustrates a method providing for hardened inter-device secure communication according to an embodiment of the present invention.

### DETAILED DESCRIPTION

Embodiments of an invention providing for hardening inter-device secure communication are described. In this description, various specific details, such as component and system configurations, may be set forth in order to provide a more thorough understanding of the present invention. It will be appreciated, however, by one skilled in the art, that the invention may be practiced without such specific details. Additionally, to avoid unnecessarily obscuring the present invention, some well-known structures, circuits, and other features have not been shown in detail.

In the following description, references to “one embodiment,” “an embodiment,” “example embodiment,” “various embodiments,” etc., indicate that the embodiment(s) of the invention so described may include particular features, structures, or characteristics, but more than one embodiment may and not every embodiment necessarily does include the particular features, structures, or characteristics. Further, some embodiments may have some, all, or none of the features described for other embodiments.

As used in the claims, unless otherwise specified, the use of the ordinal adjectives “first,” “second,” “third,” etc. to describe an element merely indicates that a particular instance of an element or different instances of like elements are being referred to, and is not intended to imply that the elements so described must be in a particular sequence, either temporally, spatially, in ranking, or in any other manner.

Communications between electronic devices key may be kept confidential or otherwise secured by encrypting the content of the communication using an encryption key shared by each of the devices. In one case, the encryption key may be a global key embedded in each device during manufacturing. However, this global key might be discovered by reverse engineering of any one such device. Therefore, it may be desired to harden these secure communications between devices using an embodiment of the present invention.

FIG. 1 illustrates integrated (IC) 100, which provides for hardening inter-device secure communication according to an embodiment of the present invention. IC 100 may represent any other component to be used in any electronic device.

For example, IC 100 may represent one or more processors integrated on a single substrate or packaged within a single package, each of which may include multiple threads and/or multiple execution cores, in any combination. Each processor may be any type of processor, including a general purpose microprocessor, such as a processor in the Intel® Core® Processor Family, Intel® Atom® Processor Family, or other processor family from Intel® Corporation, or another processor from another company, or a special purpose processor or microcontroller. IC 100 may include instruction unit 110, execution unit 120, processing storage unit 130, interface unit 140, processor control unit 150, cache unit 160, and encryption unit 170. IC 100 may also include any other circuitry, structures, or logic not shown in FIG. 1. Other embodiments of IC 100 may include all, some, or none of the units shown or described in FIG. 1.

Instruction unit 110 may represent any circuitry, structure, or other hardware, such as an instruction decoder, for fetching, receiving, decoding, and/or scheduling instructions. Any instruction format may be used within the scope of the present invention; for example, an instruction may include an opcode and one or more operands, where the opcode may be decoded into one or more micro-instructions or micro-operations for execution by execution unit 120.

Execution unit 120 may include any circuitry, structure, or other hardware, such as an arithmetic unit, logic unit, floating point unit, shifter, etc., for processing data and executing instructions, micro-instructions, and/or micro-operations.

Processing storage unit 130 may represent any type of storage usable for any purpose within IC 100; for example, it may include any number of data registers, instruction registers, status registers, configuration registers, control registers, other programmable or hard-coded registers or register files, or any other storage structures.

Interface unit 140 may represent any circuitry, structure, or other hardware, such as a bus unit, messaging unit, or any other unit, port, or interface, to allow IC 100 to communicate with other components through any type of bus, point to point, or other connection, directly or through any other component, such as a memory controller or a bus bridge.

Processor control unit 150 may include any logic, microcode, circuitry, or other hardware to control the operation of the units and other elements of IC 100 and the transfer of data within, into, and out of IC 100. Processor control unit 150 may cause IC 100 to perform or participate in the performance of method embodiments of the present invention, such as the method embodiments described below, for example, by causing IC 100 to execute instructions received by instruction unit 110 and micro-instructions or micro-operations derived from instructions received by instruction unit 110.

Cache unit 160 may include any one or more levels of cache memory in a memory hierarchy of an information processing system, implemented in static random access memory or any other memory technology. Cache unit 160 may include any combination of cache memories dedicated to or shared among any one or more execution cores or processors within IC 100 according to any known approaches to caching in information processing systems.

Encryption unit 170 may include any logic, structures, circuitry, or other hardware to execute one or more encryption algorithms and the corresponding decryption algorithms. Encryption unit 170 may also include any logic, structures, circuitry, or other hardware, as described below, necessary or desired to implement embodiments of the present invention. Some or all of the logic, structures, circuitry, or other hardware described as being within an encryption unit, may be described as such for convenience and may actually be shared with and/or included within any of the other units of IC 100.

FIG. 2 illustrates encryption unit 200, an embodiment of which may serve as encryption unit 170 in processor 100 of FIG. 1. Encryption unit 200 includes cryptography engine 210 to encrypt and decrypt information, global wrapping key (GWK) storage 220, fuses 230, key generation unit 240, and control unit 250.

GWK storage 220 may represent storage for a GWK 222 embedded into an IC during manufacturing, such as through the use of metal tie-ups and/or tie-downs, where GWK 222 may be used in embodiments of the present invention as described below. GWK 222 may be shared with other ICs, for example all ICs fabricated from the same mask set or design.

Fuses 230 may represent programmable fuses or any other programmable non-volatile memory that is available for programming during a key provisioning step in order to provide an IC with an encrypted global key (E_{PK}[GK]) 232 to be used in embodiments of the present invention as described below. After E_{PK}[GK] 232 is stored in fuses 230, fuse controller 234 may be used to obtain E_{PK}[GK] 232 from fuses 230 and provide it to cryptography engine 210 for use in embodiments of the present invention as described below.

Key generation unit 240 may include physically unclonable function (PUF) circuit 242 and PUF key generator 244. PUF circuit 242 may include any number of PUF cells to provide a unique, repeatable, and unpredictable value for PUF key generator 244 to use to generate PUF key (PK) 246.

For example, PUF circuit 242 may take advantage of variations in IC process parameters such as dopant concentrations and line widths, which may manifest themselves as differences in timing behavior between instances of the same circuit on different ICs. Therefore, each instance of a PUF circuit may provide a unique, repeatable, and unpredictable response when measured or challenged, and cloning or creating a physical copy of an instance of a PUF circuit is difficult. Any type of PUF may be used in PUF circuit 242, including but not limited to an arbiter PUF, a ring oscillator PUF, a static random access memory (SRAM) PUF, and a D-type flip-flop PUF. For example, an SRAM PUF is based on the four-cross coupled transistors of an SRAM cell, which assumes one of two stable states after power-up based on any slight mismatches among the four transistors. The mismatches are the result of variations in the fabrication process, so the power-up state for a single instance of an SRAM cell may be expected to be repeatable, but the distribution of power-up states for a number of instances of an SRAM cell may be expected to be random.

PUF key generator 244 may measure or challenge PUF circuit 242 and use the result to generate unique PK 246.

Control unit 250 may include any logic, microcode, circuitry, or other hardware to control the operation of encryption unit 200 and cause IC encryption unit 200 to perform or participate in the performance of method embodiments of the present invention, such as the method embodiments described below.

FIG. 3 illustrates method 300 for key provisioning according to an embodiment of the present invention, and FIG. 4 illustrates method 400 providing for hardening inter-device secure communication according to an embodiment of the present invention. Although method embodiments of the invention are not limited in this respect, reference may be made to elements of FIGS. 1 and 2 to help describe the method embodiments of FIGS. 3 and 4.

Method 300 may represent key provisioning during the process of manufacturing and/or testing an IC such as IC 100. In box 310 of method 300, a key server generates or otherwise provides a global key. The key server may be any server, machine, or other entity for generating, provisioning, and/or managing the provisioning of keys, and as such, has access to the value of GWK 222. Embodiments of the present invention provide for the use of GWK 222 to protect the global key on the manufacturing line.

In box 312, the key server encrypts the global key with the value of GWK 222 to obtain E_{GWK}[GK]. In box 314, the key server sends E_{GWK}[GK] to IC 100. In box 316, the key server may send E_{GWK}[GK] to another IC with which IC 100 may be desired to communicate according to embodiments of the present invention. The key server may also send E_{GWK}[GK] to any other ICs with which IC 100 may be desired to communicate according to embodiments of the present invention.

In box 320, an encryption unit of IC 100, such as encryption unit 200, receives E_{GWK}[GK]. In box 322, encryption unit 200 obtains GWK 222 from GWK storage 220. In box 324, cryptography engine 210 decrypts E_{GWK}[GK] using GWK 222 to obtain the global key.

In box 330, PUF circuit 242 assumes its stable state. In box 332, PUF key generator 244 generates PK 246 based on the stable state of PUF circuit 242. In box 334, cryptography engine 210 encrypts the global key with PK 246 to obtain E_{PK}[GK] 232. In box 336, encryption unit 200 stores E_{PK}[GK] 232 in fuses 230.

Method 400 may represent the operation of IC 100 in an information processing system. In box 410 of method 400, powering up, booting, or other initialization of IC 100 may begin.

In box 420, encryption unit 200 obtains E_{PK}[GK] 232 from fuses 230 through fuse controller 234. In box 422, PUF circuit 242 assumes its stable state. In box 424, PUF key generator 244 generates PK 246 based on the stable state of PUF circuit 242. In box 426, cryptography engine 210 decrypts E_{PK}[GK] 232 using PK 246 to obtain the global key. In box 428, the initialization of IC 100 may end.

In box 430, hardened inter-device secure communication between IC 100 and another IC which has been provisioned with the global key according to an embodiment of the present invention, such as the embodiment of method 300, and initialized according to an embodiment of the present invention, such as in boxes 410 through 428, may begin. In box 432, cryptography engine 210 uses the global key to encrypt information to be sent to the other device. In box 434, IC 100 or the device which contains IC 100 sends the encrypted information to the other device. In box 436, the other device receives the encrypted information. In box 438, the other device uses the global key, which it has obtained through the equivalent of boxes 410 through 428, to decrypt the information.

In various embodiments of the present invention, the methods illustrated in FIGS. 3 and 4 may be performed in a different order, with illustrated boxes combined or omitted, with additional boxes added, or with a combination of reordered, combined, omitted, or additional boxes. Furthermore, various other embodiments of the present invention are possible. For example, instead of inter-device secure communication as described in boxes 432 through 438, an embodiment may include inter-device secure communication using the global key according to any protocol or approach, such as the devices using the global key to authenticate each other to establish secure communications according to a secure message authentication code algorithm.

Thus, embodiments of an invention for hardening inter-device secure communication have been described. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising:
a first storage location to store an embedded key;
a second storage location to store a fuse key;
a physically unclonable function (PUF) circuit to provide a PUF value;
a PUF key generator to generate a PUF key based on the PUF value;
an encryption unit to receive from a key server a global key encrypted using the embedded key, decrypt the global key using the embedded key, encrypt the global key using the PUF key, and store the global key encrypted using the PUF key in the second storage location.

2. A method comprising:
sending, by a key server, a global key encrypted with a global wrap key;
receiving, by an integrated circuit, the global key encrypted using the global wrap key;
decrypting, by the integrated circuit, the global key using the global wrap key;
encrypting, by the integrated circuit, the global key using a physically unclonable function (PUF) key;
and burning the global key encrypted using the PUF key in fuses in the integrated circuit.

3. A system comprising:
a first device including
a first storage location to store an embedded key;
a second storage location to store a first fuse key;
a first physically unclonable function (PUF) circuit to provide a first PUF value;
a first PUF key generator to generate a first PUF key based on the first PUF value;
a first encryption unit to receive from a key server a global key encrypted using the embedded key, decrypt the global key using the embedded key, encrypt the global key using the first PUF key, and store the global key encrypted using the first PUF key in the second storage location; and
a second device including
a third storage location to store the embedded key;
a fourth storage location to store a second fuse key;
a second physically unclonable function (PUF) circuit to provide a second PUF value;
a second PUF key generator to generate a second PUF key based on the second PUF value;
a second encryption unit to receive from the key server the global key encrypted using the embedded key, decrypt the global key using the embedded key, encrypt the global key using the second PUF key, and store the global key encrypted using the second PUF key in the fourth storage location.
